(19) United States
(12) Patent Application Publication
(10) Pub. No.: US 2023/0417894 A1
(43) Pub. Date: Dec. 28, 2023

(54) METHOD AND DEVICE FOR IDENTIFYING OBJECT

(71) Applicant: HL KLEMOVE CORP., Incheon (KR)

(72) Inventor: Yong Hyeon CHO, Seoul (KR)

(21) Appl. No.: 18/196,834

(22) Filed: May 12, 2023

(30) Foreign Application Priority Data
Jun. 24, 2022 (KR) 10-2022-0077793

(51) Int. Cl. G01S 13/52; G01S 13/70; G01S 13/931

(52) U.S. Cl. CPC G01S 13/52; G01S 13/70; G01S 13/931

(57) ABSTRACT

An object identification method and device may be capable of quickly identifying the stationary state or moving state of a detected object for various movements of a radar-equipped vehicle (for example, a sharp turn such as right turn or U-turn in downtown or variously accelerated driving), enhancing the accuracy of object identification, and efficiently reducing the computation time and the requirement of memory capacity for identifying the stationary state or moving state of the detected object.

### CROSS-REFERENCE TO RELATED APPLICATION

This application claims priority from Korean Patent Application No. 10-2022-0077793, filed on Jun. 24, 2022, which is hereby incorporated by reference for all purposes as if fully set forth herein.

### BACKGROUND

### Technical Field

Embodiments of the present disclosure may generally relate to a method and device for identifying one or more objects.

### Description of Related Art

The automotive industry has been developing advanced driver assistance systems (ADAS) that provide more convenience and safety to drivers. As a representative example, a system that predicts a forward road environment using map information and provides appropriate control and convenience services is being commercialized. Further, in recent years, autonomous vehicles capable of self-driving to the destination even without the driver's manipulating a steering wheel, an accelerator pedal, or a brake have been developed.

With the advancement of autonomous driving technology, more and more complex functions, such as lane keeping assist system (LKAS), rear cross-traffic collision warning (RCCW), and blind spot collision warning (BCW), are required for user convenience and, to implement the functions in limited resources (for example, semiconductor memory capacity, operation time, price, etc.), light algorithms capable of maintaining high performance are being studied.

Among them, identifying the stationary or moving state of an object in various road environments while driving the vehicle may need to choose priority for a target to be controlled and perform track management. Further, the identification of the stationary or moving state of an object may help to form a precise map for more accurate driving or data annotation in aiming at future autonomous driving through deep learning.

Meanwhile, if the host vehicle and the target vehicle both are moving in a straight line, the stationary state or moving state of an object may be identified simply by compensating for a wheel velocity component in a range rate component measured by a radar. Therefore, the conventional driver assist system may identify the stationary state or moving state of an object determined in such a simplified manner in a high-straightness environment, e.g., a highway, and use it for smart cruise control (SCC) and automatic emergency braking (AEB).

However, it is necessary to have a technology that can accurately identify the exact stationary or moving state of an object in complex situations, such as vehicle turning situations, such as U-turns and right turns, in urban areas, not in high-straightness environments, such as highways, lateral movement of a target vehicle at intersections, and pedestrian detection. Therefore, a need exists for developing technology capable of efficiently reducing the computation time and memory capacity required for precisely identifying a detected object as a stationary object or a moving object even in complex situations according to the host vehicle's moving characteristics and using the same.

It is with respect to these and other general considerations that the following embodiments have been described. Also, although relatively specific problems have been discussed, it should be understood that the embodiments should not be limited to solving the specific problems identified in the background.

### SUMMARY

Some embodiments of the present disclosure may provide a method and device for identifying one or more objects, thereby quickly identifying a stationary state or moving state of a detected object for various movements of a radar-equipped vehicle (e.g., a sharp turn, such as right turn or U-turn in downtown or variously accelerated driving), enhancing the accuracy, and efficiently reducing the computation time and the requirement of memory capacity for identifying the stationary state or moving state.

In an aspect of the present disclosure, an object identification method may comprise an information reception step of receiving motion information about a host vehicle from a dynamics sensor and receiving range rate information about an object located around the host vehicle from a radar sensor, a predicted range rate calculation step of calculating a predicted range rate for a detected object according to a motion of the host vehicle based on the motion information about the host vehicle and the range rate information about the object, and an object identification determination step of receiving a measured range rate for the detected object after a preset time and identifying and determining the detected object as a stationary object or a moving object based on the predicted range rate and the measured range rate.

In another aspect of the present disclosure, an object identification device may comprise an information receiver receiving motion information about a host vehicle from a dynamics sensor and receiving range rate information about an object located around the host vehicle from a radar sensor, a predicted range rate calculator calculating a predicted range rate for a detected object according to a motion of the host vehicle based on the motion information about the host vehicle and the range rate information about the object, and an object identification determiner receiving a measured range rate for the detected object after a preset time and identifying and determining the detected object as a stationary object or a moving object based on the predicted range rate and the measured range rate.

The object identification method and device according to some embodiments of the present disclosure may be capable of quickly identifying the stationary state or moving state of a detected object for various movements of a radar-equipped vehicle (e.g., a sharp turn such as right turn or U-turn in downtown or variously accelerated driving), enhancing the accuracy of object identification, and efficiently reducing the computation time and the requirement of memory capacity for identifying the stationary state or moving state of the detected object.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF DRAWINGS

The above and other objects, features, and advantages of the disclosure will be more clearly understood from the following detailed description, taken in conjunction with the accompanying drawings, in which:

FIG. 1 is a flowchart for illustrating an object identification method according to an embodiment of the present disclosure;

FIG. 2 is a flowchart for illustrating a process of determining a detected object as a moving object or a stationary object in an object identification method according to an embodiment of the present disclosure;

FIG. 3 is a view for illustrating an example a range rate according to an embodiment of the present disclosure;

FIG. 4 is a flowchart for illustrating a correction step in an object identification method according to an embodiment of the present disclosure;

FIG. 5 is a view for illustrating an example of a moving object in an object identification method according to an embodiment of the present disclosure;

FIG. 6 is a view for illustrating an example of a stationary object in an object identification method according to an embodiment of the present disclosure;

FIG. 7 is a view for illustrating a moving object and a stationary object according to an object identification method according to an embodiment of the present disclosure;

FIG. 8 is a graph for illustrating a cycle time according to an object identification method according to an embodiment of the present disclosure; and

FIG. 9 is a block diagram for illustrating an object identification device according to an embodiment of the present disclosure.

FIG. 10 shows a block diagram of a computer system according to an embodiment of the present disclosure.

### DETAILED DESCRIPTION

In the following description of examples or embodiments of the disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the disclosure, detailed descriptions of well-known functions and components incorporated herein will be omitted when it is determined that the description may make the subject matter in some embodiments of the disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

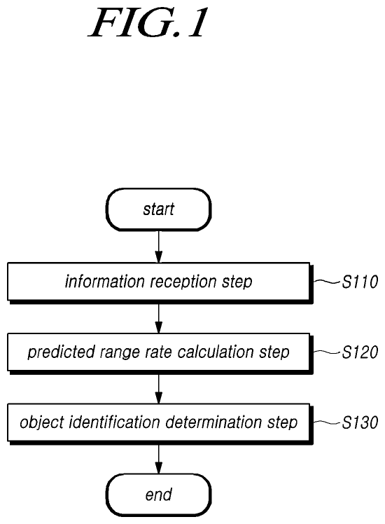

FIG. 1 is a flowchart for illustrating an object identification method according to an embodiment of the present disclosure.

Referring to FIG. 1, an object identification method according to an embodiment of the present disclosure may include an information reception step (Step S110) receiving motion information about motion of a host vehicle from a dynamics sensor, and receiving range rate information about a range rate of an object located around the host vehicle from a radar sensor.

The dynamics sensor may be a sensor equipped in or associated with the host vehicle to sense dynamical motion information about motion of the host vehicle and may be implemented as a single sensor or a plurality of sensors. For example, the dynamics sensor may include a velocity sensor for sensing velocity information about a velocity of the host vehicle and a gyro sensor for sensing rotation state information about the rotation state of the host vehicle. However, without limitations thereto, a wheel velocity sensor may be used instead of or in addition to the velocity sensor, and calculate the velocity information about the velocity of the host vehicle. Further, a steering angle sensor may be used instead of or in addition to the gyro sensor in order to produce rotation state information about a rotation state of the host vehicle. In other words, in embodiments of the present disclosure, the dynamics sensor is not limited to a specific type sensor and may be any sensor capable of receiving dynamical information, such as the velocity information about the host vehicle and the rotation state of the host vehicle, and the motion information about the motion of the host vehicle may mean information sensed by the dynamics sensor or be produced based on dynamics sensing information.

The radar sensor may receive range rate information about a range rate of an object positioned around the host vehicle. For example, the radar sensor may be a Doppler radar as a continuous wave radar. However, without limitations thereto, as another example, the radar sensor may be a modulated continuous wave radar or a pulse radar. In other words, any type of radar sensor may be used or included as long as it may receive information about a distance to an object positioned around the host vehicle.

The radar sensor may receive range rate information about the range rate of the object. However, without limitations thereto, the range rate information of the object may be calculated based on a change in a distance between the object and the host vehicle and the detection time. The range rate information about the range rate of the object may mean, for instance, but not limited to, a change in a relative velocity between the host vehicle and the object.

Referring to FIG. 1, the object identification method according to an embodiment of the present disclosure may include a predicted range rate calculation step (Step S120) of calculating a predicted range rate of a detected object according to the motion of the host vehicle determined based on the motion information about the motion of the host vehicle and the range rate information about the object, which are received at Step S110.

The predicted range rate may be calculated by predicting range rate information about a range rate of the detected object from predicted location information about a location of the host vehicle after a preset time based on the motion information about the motion of the host vehicle. The predicted location information about the location of the host vehicle may mean information about the location and/or rotation state of the host vehicle predicted at a point in time after a preset time based on the velocity information and rotation state information included in the motion information about the motion of the host vehicle.

For example, the predicted range rate may be calculated under the assumption that the detected object is a stationary object. If the detected object is a stationary object, the absolute velocity of the detected object is 0, so that the predicted range rate may be calculated by considering only the predicted location information about the host vehicle. Therefore, memory capacity and computation time may be effectively reduced.

Since the predicted range rate is calculated based on the motion information about the motion of the host vehicle and is used to identify and determine whether the detected object is a stationary object or a moving object, it is possible to quickly identify the state of the detected object in various maneuvers of the host vehicle, for example sharp turns, such as right turns and U-turns in downtown or variously accelerated driving.

Referring to FIG. 1, the object identification method according to an embodiment of the present disclosure may include an object identification determination step (S130) of receiving a measured range rate of the detected object after a preset time, and identifying and determining whether the detected object is a stationary object or moving object based on the predicted range rate calculated at Step S120 and the measured range rate.

The preset time for receiving the measured range rate of the detected object may be set based on the scan period of the radar sensor. For example, the preset time may mean a time within the same scan of the radar sensor. However, without limitations thereto, the preset time may mean the time between multiple scans of the radar sensor.

The object identification determination step (Step S130) may calculate a difference value between the predicted range rate of the detected object calculated at Step S120 and the measured range rate of the detected object received at Step S130, compare the calculated difference value with a preset threshold, and identify and determine whether the detected object is a stationary object or moving object.

The preset threshold may be a value experimentally obtained to be set, and may be set as one fixed value. However, without limitations thereto, the threshold may be set to be varied according to the location of the detected object or the velocity component of the host vehicle. For example, the threshold may be differently set according to the distance between the detected object and the host vehicle, or according to the change in the velocity of the host vehicle. However, even when the threshold is set to be varied according to the location of the detected object or the velocity component of the host vehicle, the difference between the thresholds may be set to be relatively small. In this case, the stationary state or moving state of the detected object may be identified and determined based on an average threshold which is the average of the plurality of different thresholds as set.

For example, the object identification determination step (Step S130) may determine that the detected object is a moving object if the difference value between the predicted range rate of the detected object calculated at Step S120 and the measured range rate of the detected object received at Step S130 is equal to or greater than the threshold. And, the object identification determination step (Step S130) may determine that the detected object is a stationary object if the difference value between the predicted range rate of the detected object calculated at Step S120 and the measured range rate of the detected object received at Step S130 is less than the threshold. However, the present disclosure is not limited thereto. As another example, the object identification determination step (Step S130) may determine that the detected object is a moving object if the difference value between the predicted range rate of the detected object calculated at Step S120 and the measured range rate of the detected object received at Step S130 exceeds the threshold and that the detected object is a stationary object if the difference value between the predicted range rate of the detected object calculated at Step S120 and the measured range rate of the detected object received at Step S130 is equal to or less than the threshold. In other words, if the difference value between the predicted range rate of the detected object calculated at Step S120 and the measured range rate of the detected object received at Step S130 is the same as the threshold, the detected object may be determined to be a moving object or a stationary object according to settings.

Although not shown in FIG. 1, the object identification method may further include a correction step of correcting the motion information about the motion of the vehicle based on the result of determining whether the detected object is a stationary object or moving object after the object identification determination step (Step S130).

For example, the correction step may be performed only when it is determined that the detected object is a stationary object. In this case, the correction step may correct the motion information to reduce the difference value between the predicted range rate and the measured range rate. Further, the correction step may correct the motion information about the motion of the vehicle received from the dynamics sensor or correct dynamics parameters of the dynamics sensor.

The motion information about the motion of the vehicle used for determining whether the detected object is a stationary object or moving object may be sensitively changed depending on the maneuver of the host vehicle. Meanwhile, some embodiments of the present disclosure may correct motion information that affects the maneuver of the host vehicle with respect to a stationary object. Thus, the correction can be performed by considering only the motion state of the host vehicle. Therefore, it is possible to further enhance the accuracy of determination as to whether the detected object is in the stationary state or moving state while reducing the determination time.

The above-described object identification method according to certain embodiments of the present disclosure may be capable of quickly identifying a state of a detected object, for example, but not limited to, the stationary state or moving state of a detected object for various movements of a radar-equipped host vehicle (e.g., a sharp turn, right turn or U-turn in downtown or variously accelerated driving), enhancing the accuracy, and efficiently reducing the computation time and memory capacity required for identifying the stationary state or moving state.

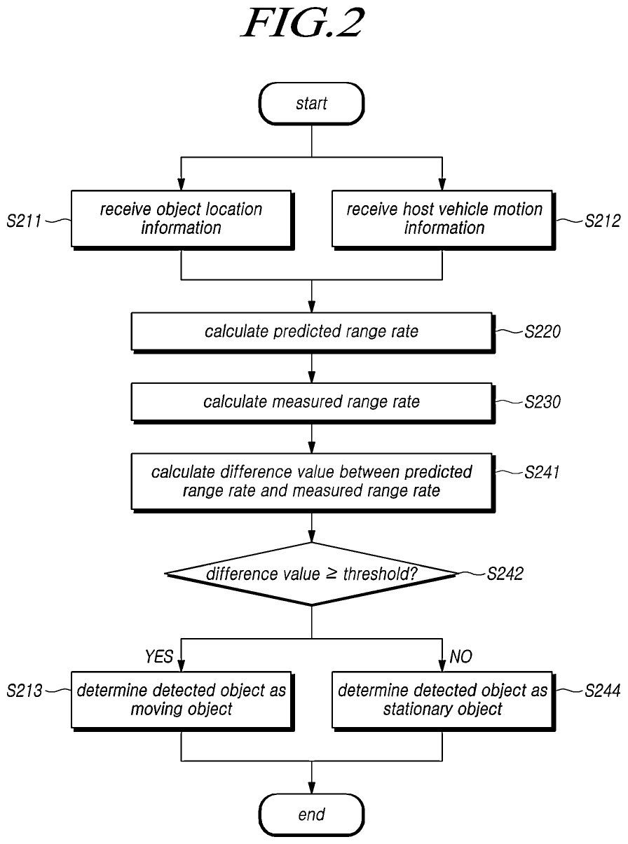

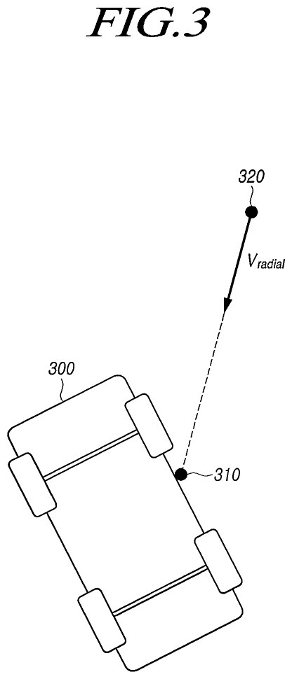

FIG. 2 is a flowchart for illustrating a process of determining a detected object as a moving object or a stationary object in an object identification method according to an embodiment of the present disclosure. FIG. 3 is a view for illustrating an example of a range rate according to an embodiment of the present disclosure.

Referring to FIG. 2, an object identification method according to an embodiment of the present disclosure may receive range rate information about a range rate of an object located around the host vehicle from the radar sensor (Step S211) and receive motion information about a motion of the host vehicle from the dynamics sensor (Step S212).

Referring to FIG. 3, the range rate may mean a change in a relative velocity V_{radial} of the object 320 relative to the radar sensor 310 equipped in the host vehicle 300 in the centrifugal direction. The predicted range rate and the measured range rate which are changed as the host vehicle is maneuvered as described below may also mean a change in a relative velocity V_{radial} of the detected object relative to the radar sensor 310 equipped in the host vehicle 300 in the centrifugal direction.

In FIG. 3, only the left side radar sensor 310 of the host vehicle 300 is shown, but is not limited thereto. For example, the host vehicle 300 may further include a front radar sensor provided on the front surface, a right side radar sensor provided on the right side, and a rear radar sensor provided on the rear side.

Each of the front radar sensor, the right side radar sensor, the left side radar sensor 310 and the rear radar sensor may simultaneously sense range rate information about range rates of a plurality of objects around the vehicle. Accordingly, since the plurality of objects around the host vehicle may be simultaneously sensed by the plurality of radar sensors, the operations of identifying and determining each of the plurality of detected objects as a stationary object or a moving object, respectively, can be simultaneously performed.

Referring back to FIG. 2, the predicted range rate may be calculated by predicting range rate information about the range rate of the detected object from predicted location information about the location of the host vehicle after a preset time based on the range rate information of the object received at Step S211 and the motion information of the host vehicle received at Step S212 (Step S220). In this case, the predicted range rate may be calculated under the assumption that the detected object is a stationary object.

A measured range rate of the detected object may be received after a preset time (Step S230). The preset time used to receive the measured range rate and the preset time used to calculate the predicted range rate may be the same as each other. Accordingly, the predicted range rate and the measured range rate obtained at the same time may be compared with each other.

The predicted range rate and the measured range rate may be compared to obtain a difference value therebetween (Step S421). For example, I difference value may be obtained by subtracting the predicted range rate from the measured range rate.

The obtained difference value between the predicted range rate and the measured range rate may be compared with a preset threshold, in order to determining whether the difference value is equal to or greater than the threshold (Step S242). If the difference value between the predicted range rate and the measured range rate is equal to or greater than the threshold, the detected object may be determined to be a moving object (Step S243). In contrast, if the difference value between the predicted range rate and the measured range rate is less than the threshold, the detected object may be determined to be a stationary object (Step S244).

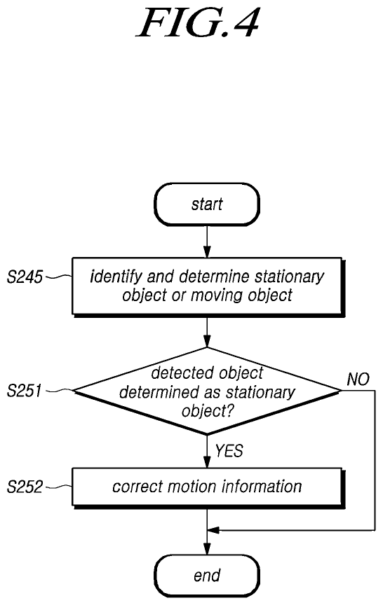

FIG. 4 is a flowchart for illustrating a correction step in an object identification method according to an embodiment of the present disclosure.

Referring to FIG. 4, the object identification method according to an embodiment of the present disclosure may identify and determine a detected object as a stationary object or a moving object (Step S245). Further, the object identification method may identify and determine whether the detected object is determined to be a stationary object at Step 245 (Step S251).

When the detected object is determined to be a stationary object, the motion information about a motion of the vehicle may be corrected based on the difference between the predicted range rate and the measured range rate of the stationary object (Step S252). For example, the motion information about the motion of the vehicle may be corrected to reduce the difference value between the predicted range rate and the measured range rate. Accordingly, the accuracy of calculation of the calculated predicted range rate may further be enhanced, and the accuracy of determination of the detected object as a stationary object or a moving object may increase.

Meanwhile, if the detected object is not a stationary object (or if the detected object is determined to be a moving object), the motion information about the motion of the vehicle may not need to be corrected. If the detected object is a moving object, both an error according to the motion information about the movement of the host vehicle and an error according to the motion state of the moving object may simultaneously be reflected. Accordingly, the accuracy of the predicted range rate calculated may be reduced when correcting the motion information about the motion of the vehicle based on the moving object. Thus, only when the detected object is determined to be a stationary object, the detected object may be corrected based thereupon.

The correction of the motion information about the motion of the vehicle may be performed by correcting the motion information about the motion of the vehicle received from the dynamics sensor. However, the present disclosure is not limited thereto. For example, the correction of the motion information about the motion of the vehicle may also be performed by estimating an error in one or more dynamics parameters of the dynamics sensor and correcting the estimated dynamics parameter(s). In other words, the correction may be performed by correcting the motion information about the motion of the vehicle received from the dynamics sensor or correcting the dynamics parameter(s) of the dynamics sensor to receive corrected motion information.

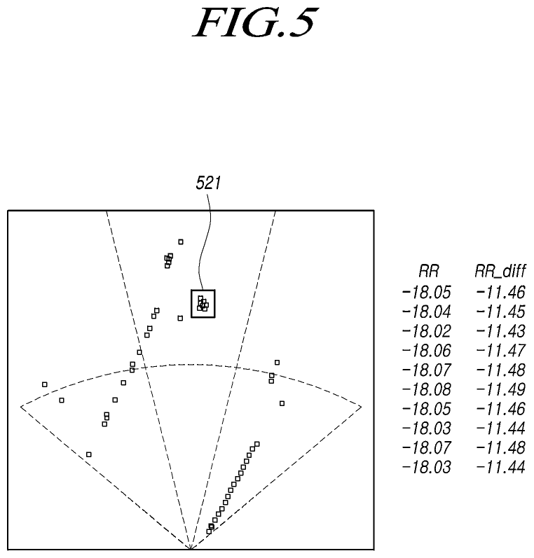

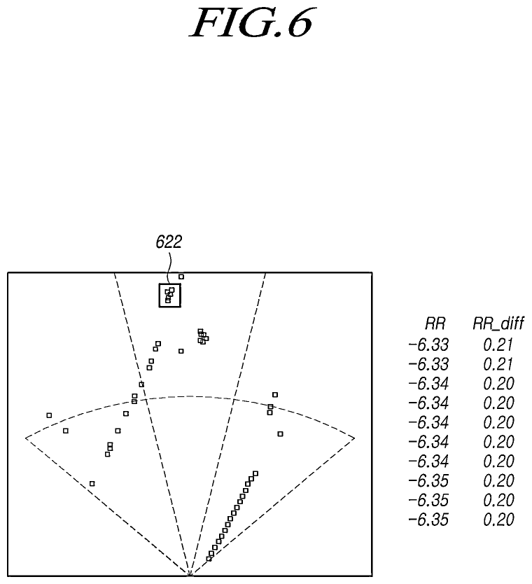

FIG. 5 is a view for illustrating an example of a moving object in an object identification method according to an embodiment of the present disclosure. FIG. 6 is a view for illustrating an example of a stationary object in an object identification method according to an embodiment of the present disclosure.

FIGS. 5 and 6 illustrate an example of a situation in which a detected object is determined to be a moving object or a stationary object while the host vehicle makes a right turn at about 17 deg/sec by an object identification method according to an embodiment of the present disclosure.

Described with reference to FIGS. 5 and 6 is an example in which when the host vehicle is turning right at about 17 deg/sec, the predicted range rate calculated under the assumption that the detected object is a stationary object based on the motion information about the motion of the host vehicle is −6.5 m/s. However, the predicted range rate calculated under the assumption that the detected object is a stationary object according to the motion state of the host vehicle, such as information about a velocity of the host vehicle and information about a rotation state of the vehicle, is not limited to the above-described example values, but may rather be calculated as other values.

Further, in the described example, the preset threshold is set to 1. However, without limitations thereto, the threshold may be set to a value larger than 1 or a value smaller than 1. Meanwhile, as the threshold is set to a value close to 0, the accuracy of determining whether the detected object is a stationary object or a moving object may be further enhanced.

According to an embodiment of the present disclosure, if the threshold is set to a value close to 0 in the object identification method, the detected object may be determined to be a moving object even when the object moves slowly around 1 m/s like a pedestrian.

Further, when comparing the difference value between the predicted range rate and the measured range rate with the threshold, the absolute value of the difference value between the predicted range rate and the measured range rate may be used. In this case, a front detected object approaching toward the front of the host vehicle and a rear detected object moving away from the rear of the host vehicle may simultaneously be determined to be stationary objects or moving objects based on one threshold.

Referring to FIG. 5, in a situation in which a moving object 521 (e.g., another moving vehicle is detected, range rates may be detected with a plurality of points for the other vehicle. In this case, a predicted range rate may be obtained for each of the plurality of points, and a measured range rate measured after a preset time may be received for each of the plurality of points.

As shown in FIG. 5, the received measured range rate RR may be a value between −18.02 m/s and −18.08 m/s for each of the plurality of points, and if the predicted range rate is obtained as −6.5 m/s, the difference value RR diff between the predicted range rate and the measured range rate may be obtained as a value between −11.44 m/s and −11.49 m/s, and the difference values RR diff may have a distribution within 0.1 m/s.

In FIG. 5, the absolute value RR diff between the predicted range rate and the measured range rate may be a value between 11.44 and 11.49, and since it is equal to or larger than 1 (i.e., a predetermined threshold), the detected object may be determined to be the moving object 521.

Referring to FIG. 6, in a situation in which a stationary object 622 (e.g., a guardrail) is detected, range rates may be detected with a plurality of points for the guardrail. In this case, a predicted range rate may be obtained for each of the plurality of points, and a measured range rate measured after a preset time may be received for each of the plurality of points.

As shown in FIG. 6, the received measured range rate RR may be a value between −6.33 m/s and −6.35 m/s for each of the plurality of points, and if the predicted range rate is obtained as −6.5 m/s, the difference value RR diff between the predicted range rate and the measured range rate may be obtained as a value between 0.20 m/s and 0.21 m/s, and the difference values RR diff may have a distribution within 0.01 m/s.

In FIG. 6, the absolute value RR diff between the predicted range rate and the measured range rate may be a value between 0.20 and 0.21, and since it is less than 1 (i.e., a predetermined threshold), the detected object may be determined to be the stationary object 622.

If the detected object is determined to be the stationary object 622, the motion information about the motion of the host vehicle may be corrected based on the difference value RR diff between the predicted range rate and the measured range rate. If a plurality of difference values RR diff are obtained, the motion information about the motion of the host vehicle may be corrected using a median value. Here, the median value may mean a value that can minimize the sum of the absolute values of the difference values RR diff.

The motion information about the motion of the host vehicle may be corrected to reduce the difference value RR diff between the predicted range rate and the measured range rate. Thus, the difference value RR diff between the predicted range rate and the measured range rate may be calculated as a value close to 0 by the correction to the motion information about the motion of the host vehicle.

The difference values RR diff of FIGS. 5 and 6 are compared. If the moving object 521 is rotated, the distribution of difference values RR diff between the predicted range rate and the measured range rate is 0.1 m/s. However, since the stationary object 622 cannot be rotated, the distribution of the difference values RR diff between the predicted range rate and the measured range rate may be calculated as 0.01 m/s. In other words, if the detected object is the stationary object 622, the distribution of the difference values RR diff may be calculated to be small. However, if the detected object is the moving object 621, the distribution of the difference values RR diff between the predicted range rate and the measured range rate may be calculated to be larger than those for the stationary object according to the motion state of the moving object. Accordingly, it is possible to further enhance the accuracy of the determination of the state of the detected object by correcting the motion information about the motion of the host vehicle based on the stationary object which has a smaller distribution of difference values RR diff between the predicted range rate and the measured range rate.

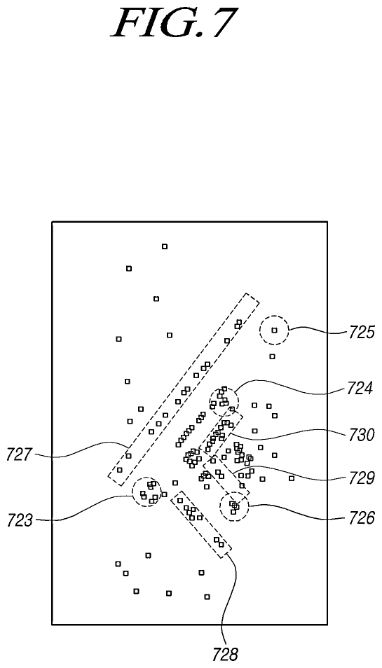

FIG. 7 is a view for illustrating a moving object and a stationary object according to an object identification method according to an embodiment of the present disclosure.

FIG. 7 illustrates an example situation in which when the host vehicle turns right at a three-way intersection, objects 723, 724, 725, and 726 are identified and determined as moving objects and objects 727, 728, 729, and 730 are identified and determined as stationary objects. The moving objects 723, 724, 725, and 726 may be other vehicles, and the stationary objects 727, 728, 729, and 730 may be guardrails.

For each detected object, range rate information may be received from front, left, right, and rear radar sensors provided to the host vehicle, and each of the detected objects may simultaneously be identified and determined as a stationary object or a moving object based on the motion information about the motion of the host vehicle and the range rate information about a range rate of each object.

According to the object identification method according to an embodiment of the present disclosure, it is possible to identify the stationary state or moving state at the object measurement end of the detected object, but not at the track end of the detected object. Accordingly, the object identification method according to an embodiment of the present disclosure may efficiently reduce the computation time and the requirement of memory capacity for identifying the stationary state or moving state.

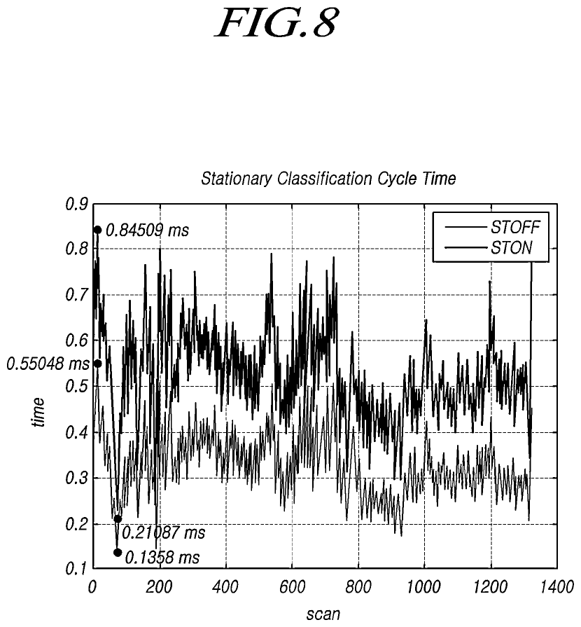

FIG. 8 is a graph for illustrating a cycle time according to an object identification method according to an embodiment of the present disclosure.

FIG. 8 is a view of illustrating a cycle time when an object identification method according to an embodiment of the present disclosure is operated on a radar sensor processing the object measurements of about 200 detected objects.

The maximum time required for the radar sensor to process the object measurements of about 200 detected objects is 0.55048 ms, and the minimum time is 0.1358 ms.

The maximum time required when the radar sensor processes the object measurements of about 200 detected objects and the object identification method according to an embodiment of the present embodiment operates is 0.84509 ms, and the minimum time is ms.

In other words, the comparison between the time required for the radar sensor to process the object measurements of about 200 detected objects and the time required for processing object measurements and operating the object identification method according to an embodiment of the present disclosure shows that the time increase for the operation of the object identification method according to an embodiment of the present disclosure may be very small amount.

Further, the time further required when the radar sensor processes the object measurements of about 200 detected objects, and the object identification method according to an embodiment of the present disclosure operates is 3 ms or less for its maximum value, and 1 ms or less for its minimum value. Thus, a very short time may be additionally needed to identify and determine the detected object as a stationary object.

The above-described object identification method according to an embodiment of the present disclosure is capable of quickly identifying the stationary state or moving state of a detected object for various movements of a radar-equipped host vehicle (e.g., a sharp turn, such as right turn or U-turn in downtown or variously accelerated driving), enhancing the accuracy of the object detection, and efficiently reducing the computation time and the requirement of the memory capacity for identifying the stationary state or moving state.

The object identification method described in connection with FIGS. 1 to 8 can be implemented in an object identification device according to an embodiment of the present disclosure. The object identification device described below may perform all or some operations of the above-described object identification method. Further, the object identification device may perform any combination of the above-described embodiments.

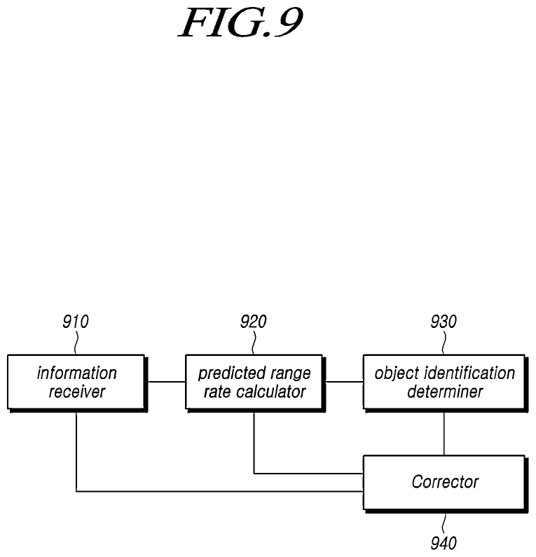

FIG. 9 is a block diagram for illustrating an object identification device according to an embodiment of the present disclosure.

Referring to FIG. 9, an object identification device according to the present embodiments may include an information receiver 910 configured to receive motion information about a motion of a host vehicle from a dynamics sensor and receiving range rate information about a range rate of an object located around the host vehicle from a radar sensor.

The dynamics sensor may be a sensor equipped in or associated with the host vehicle to sense dynamical motion information about a motion of the host vehicle and may be implemented as a single sensor or a plurality of sensors. For example, the dynamics sensor may include a velocity sensor for sensing velocity information about a velocity of the host vehicle and a gyro sensor for sensing rotation state information about a rotation state of the host vehicle. However, without limitations thereto, a wheel velocity sensor may be used instead of or in addition to the velocity sensor, and calculate the velocity information about the velocity of the host vehicle. Further, a steering angle sensor may be used instead of or in addition to the gyro sensor, in order to produce rotation state information about a rotation state of the host vehicle. In other words, in embodiments of the present disclosure, the dynamics sensor is not limited to a specific type sensor and may be any sensor capable of receiving dynamical information, such as the velocity information about the host vehicle and the rotation state of the host vehicle, and the motion information about the motion of the host vehicle may mean information sensed by the dynamics sensor or be produced based on dynamics sensing information.

The radar sensor may receive range rate information about a range rate of an object positioned around the host vehicle. For example, the radar sensor may be a Doppler radar as a continuous wave radar. However, without limitations thereto, as another example, the radar sensor may be a modulated continuous wave radar or a pulse radar. In other words, any type of radar sensor may be used or included as long as it may receive information about a distance to an object positioned around the host vehicle.

The radar sensor may receive range rate information about the range rate of the object. However, without limitations thereto, the range rate information of the object may be calculated based on a change in distance between the object and the host vehicle and the detection time. The range rate information about the range rate of the object may mean, for instance, but not limited to, a change in a relative velocity between the host vehicle and the object.

Referring to FIG. 9, the object identification device according to an embodiment of the present disclosure may include a predicted range rate calculator 920 configured to calculate a predicted range rate for a detected object according to the motion of the host vehicle based on the motion information about the motion of the host vehicle and the range rate information about the range rate of the object.

The predicted range rate may be calculated by predicting range rate information about a range rate of the detected object from predicted location information about a location of the host vehicle after a preset time based on the motion information about the motion of the host vehicle. The predicted location information about the location of the host vehicle may mean information about the location and/or rotation state of the host vehicle predicted at a point in time after a preset time based on the velocity information and rotation state information included in the motion information about the motion of the host vehicle.

For example, the predicted range rate may be calculated under the assumption that the detected object is a stationary object. If the detected object is a stationary object, the relative velocity of the detected object is 0, so that the predicted range rate may be calculated by considering only the predicted location information about the host vehicle. Therefore, memory capacity and computation time may be effectively reduced.

Since the predicted range rate is calculated based on the motion information about the motion of the host vehicle and is used to identify and determine whether the detected object is a stationary object or a moving object, it is possible to quickly identify the state of the detected object in various maneuvers of the host vehicle, for example sharp turns, such as right turns and U-turns in downtown or variously accelerated driving.

Referring to FIG. 9, the object identification device according to an embodiment of the present disclosure may include an object identification determiner 930 configured to receive a measured range rate of the detected object after a preset time and identifying and determining whether the detected object is a stationary object or moving object based on the predicted range rate and the measured range rate.

The preset time for receiving the measured range rate of the detected object may be set based on the scan period of the radar sensor. For example, the preset time may mean a time within the same scan of the radar sensor. However, without limitations thereto, the preset time may mean the time between multiple scans of the radar sensor.

The object identification determiner 930 may be configured to calculate a difference value between the predicted range rate calculated by the predicted range rate calculator 920 and the measured range rate, compare the calculated difference value with a preset threshold, and identify and determine whether the detected object is a stationary object or moving object.

The preset threshold may be a value experimentally obtained to be set, and may be set as one fixed value. However, without limitations thereto, the threshold may be set to be varied according to the location of the detected object or the velocity component of the host vehicle. For example, the threshold may be differently set according to the distance between the detected object and the host vehicle, or set to be varied according to the change in the velocity of the host vehicle. However, even when the threshold is set to differ according to the location of the detected object or the velocity component of the host vehicle, the difference between the thresholds may be set to be relatively small. In this case, the stationary state or moving state of the detected object may be identified and determined based on an average threshold which is the average of the plurality of different thresholds as set.

For example, the object identification determiner 930 may determine that the detected object is a moving object if the difference value between the predicted range rate of the detected object and the measured range rate of the detected object is equal to or greater than the threshold. And, the object identification determiner 930 may determine that the detected object is a stationary object if the difference value between the predicted range rate of the detected object and the measured range rate of the detected object is less than the threshold. However, an embodiment of the present disclosure is not limited thereto. As another example, the object identification determiner 930 may determine that the detected object is a moving object if the difference value between the predicted range rate of the detected object and the measured range rate of the detected object exceeds the threshold and that the detected object is a stationary object if the difference value between the predicted range rate of the detected object and the measured range rate of the detected object is equal to or less than the threshold. In other words, if the difference value between the predicted range rate of the detected object and the measured range rate of the detected object is the same as the threshold, the detected object may be determined to be a moving object or a stationary object according to settings.

Although not shown in FIG. 9, the object identification device may further include a corrector 940 configured to correct the motion information about the motion of the vehicle based on the result of determining whether the detected object is a stationary object or moving object after the object identification determination step.

For example, the corrector 940 may perform correction only when it is determined the detected object is a stationary object. In this case, the corrector 940 may correct the motion information to reduce the difference value between the predicted range rate and the measured range rate. Further, the corrector 940 may correct the motion information about the motion of the vehicle received from the dynamics sensor or correct dynamics parameters of the dynamics sensor.

The motion information about the motion of the vehicle used for determining whether the detected object is a stationary object or moving object may be sensitively changed depending on the maneuver of the host vehicle. Meanwhile, some embodiments of the present disclosure may correct motion information that affects the maneuver of the host vehicle with respect to a stationary object. Thus, the correction can be performed by considering only the motion state of the host vehicle. Therefore, it is possible to further enhance the accuracy of determination as to whether the detected object is in the stationary state or moving state while reducing the determination time.

The above-described object identification device according to certain embodiments of the present disclosure may be capable of quickly identifying a state of a detected object, for example, but not limited to, the stationary state or moving state of a detected object for various movements of a radar-equipped host vehicle (e.g., a sharp turn, right turn or U-turn in downtown or variously accelerated driving), enhancing the accuracy, and efficiently reducing the computation time and memory capacity required for identifying the stationary state or moving state.

The above-described object identification device may be implemented as, for example, an electronic control unit (ECU).

According to an embodiment of the present disclosure, a computer system, such as the object identification device, may be implemented as the ECU. The ECU may include at least one or more of one or more processors, a circuit, a memory, a storage unit, a user interface input unit, or a user interface output unit which may communicate with one another via a bus. The computer system may also include a network interface for accessing a network. The processor may be a central processing unit (CPU) or semiconductor device that is capable of executing processing instructions stored in the memory and/or the storage unit. The memory and the storage unit may include various types of volatile/non-volatile storage media. For example, the memory may include a read only memory (ROM) and a random access memory (RAM).

Specifically, the object identification device according to an embodiment of the present disclosure and the information receiver 910, the predicted range rate calculator 920, and the object identification determiner 930 included therein may be implemented as some modules of the control device or ECU of the radar system installed in the vehicle.

The control device or ECU of the object identification system according to an embodiment of the present disclosure may include a processor, a storage device, such as memory, and a computer program capable of performing specific functions, and the above-described information receiver 910, predicted range rate calculator 920, and object identification determiner 930 may be implemented as software modules capable of performing their respective corresponding functions.

In other words, the information receiver 910, predicted range rate calculator 920, and object identification determiner 930 according to an embodiment of the present disclosure may be implemented as their respective corresponding software modules which are then stored in the memory, and each software module may be performed by a computation processing device, such as the ECU included in the steering system of the host vehicle, at a specific time.

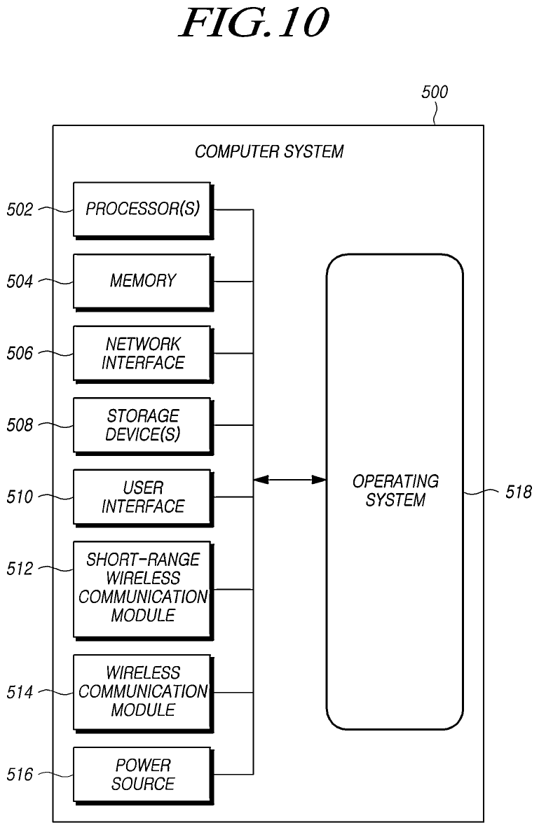

FIG. 10 illustrates a block diagram illustrating components of an example of a computer system 500. As discussed above, the information receiver 910, the predicted range rate calculator 920, the object identification determiner 930, and the corrector 940 of FIG. 9 can be implemented as the computer system. FIG. 10 illustrates only one particular example of the computer system, and many other examples of the computer system may be used in other instances.

As shown in the specific example of FIG. 10, the computer system 500 may include one or more processors 502, memory 504, network interface 506, one or more storage devices 508, user interface 510, short-range wireless communication module 512, wireless communication module 514, and power source 516. Computer system 500 may also include operating system 518, which may include modules and/or applications that are executable by one or more processors 502 and computer system 500. Each of the components 502, 504, 506, 508, 510, 512, 514, 516, and 518 may be interconnected (physically, communicatively, and/or operatively) for inter-component communications.

One or more processors 502, in one example, may be configured to implement functionality and/or process instructions for execution within computer system 500. For example, one or more processors 502 may be capable of processing instructions stored in memory 504 or instructions stored on one or more storage devices 508. These instructions may define or otherwise control the operation of operating system 518.

Memory 504 may, in one example, be configured to store information within computer system 500 during operation. Memory 504, in some examples, may be described as a computer-readable storage medium. In some examples, memory 504 may be a temporary memory, meaning that a primary purpose of memory 504 is not long-term storage. Memory 504 may, in some examples, be described as a volatile memory, meaning that memory 504 does not maintain stored contents when computer system 500 is turned off. Examples of volatile memories may include random access memories (RAM), dynamic random access memories (DRAM), static random access memories (SRAM), and other forms of volatile memories known in the art. In some examples, memory 504 may be used to store program instructions for execution by one or more processors 502. Memory 504 may, in one example, be used by software or applications running on the computer system 500 to temporarily store information during program execution.

One or more storage devices 508 may, in some examples, also include one or more computer-readable storage media. One or more storage devices 508 may be configured to store larger amounts of information than memory 504. One or more storage devices 508 may further be configured for long-term storage of information. In some examples, one or more storage devices 508 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computer system 500 may, in some examples, also include network interface 506. Computer system 500 may, in one example, use network interface 506 to communicate with external devices via one or more networks. Network interface 506 may be a network interface card, such as an Ethernet card, an optical transceiver, a radio frequency transceiver, or any other type of device that can send and receive information. Other examples of such network interfaces may include Bluetooth, 5G and Wi-Fi radios in mobile computing devices as well as universal serial bus (USB). In some examples, computer system 500 may the network interface 506 to wirelessly communicate with an external device such as a server, mobile phone, or other networked computing device.

Computer system 500 may, in one example, also include user interface 510. User interface 510 may be configured to receive input from a user (e.g., tactile, audio, or video feedback). User interface 510 may include a touch-sensitive and/or a presence-sensitive screen or display, mouse, a keyboard, a voice responsive system, or any other type of device for detecting a command from a user. In some examples, user interface 510 may include a touch-sensitive screen, mouse, keyboard, microphone, or camera.

User interface 510 may also include, combined or separate from input devices, output devices. In this manner, user interface 510 may be configured to provide output to a user using tactile, audio, or video stimuli. In one example, user interface 510 may include a touch-sensitive screen or display, sound card, a video graphics adapter card, or any other type of device for converting a signal into an appropriate form understandable to humans or machines. In addition, user interface 510 may include a speaker, a cathode ray tube (CRT) monitor, a liquid crystal display (LCD), or any other type of device that can generate intelligible output to a user.

Computer system 500, in some examples, may include power source 516, which may be a rechargeable battery and may provide power to computer system 500. Power source 516 may, in some examples, be a battery made from nickel-cadmium, lithium-ion, or other suitable material. In other examples, power source 516 may be a power source capable of providing stored power or voltage from another power source.

In addition, computer system 500 may include short-range wireless communication module 512. Short-range wireless communication module 512 may be active hardware that is configured to communicate with other short-range wireless communication modules. Examples of short-range wireless communication module 512 may include an NFC module, an RFID module, and the like. In general, short-range wireless communication module 512 may be configured to communicate wirelessly with other devices in physical proximity to short-range wireless communication module 512 (e.g., less than approximately ten centimeters, or less than approximately four centimeters). In other examples, short-range wireless communication module 512 may be replaced with an alternative short-range communication device configured to communicate with and receive data from other short-range communication devices. These alternative short-range communication devices may operate according to Bluetooth, Ultra-Wideband radio, or other similar protocols. In some examples, short-range wireless communication module 512 may be an external hardware module that is coupled with computer system 500 via a bus (such as via a Universal Serial Bus (USB) port). short-range wireless communication module 512, in some examples, may also include software which may, in some examples, be independent from operating system 518, and which may, in some other examples, be a sub-routine of operating system 518.

The computer system 500, in some examples, may also include wireless communication module 514. Wireless communication module 514 may, in some examples, may be a device operable to exchange data with other wireless communication modules over short distances (e.g., less than or equal to ten meters). Examples of wireless communication module 514 may include a Bluetooth module, a WiFi direct module, and the like.

Computer system 500 may also include operating system 518. Operating system 518 may, in some examples, control the operation of components of computer system 500. For example, operating system 518 may, in one example, facilitate the interaction with one or more processors 502, memory 504, network interface 506, one or more storage devices 508, user interface 510, short-range wireless communication module 512, wireless communication module 514, and power source 516.

Any applications implemented within or executed by Computer system 500 may be implemented or contained within, operable by, executed by, and/or be operatively/communicatively coupled to components of computer system 500 (e.g., one or more processors 502, memory 504, network interface 506, one or more storage devices 508, user interface 510, short-range wireless communication module 512, wireless communication module 514, and/or power source 516).

The above description has been presented to enable any person skilled in the art to make and use the technical idea of the disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the disclosure. The above description and the accompanying drawings provide an example of the technical idea of the disclosure for illustrative purposes only. That is, the disclosed embodiments are intended to illustrate the scope of the technical idea of the disclosure. Thus, the scope of the disclosure is not limited to the embodiments shown, but is to be accorded the widest scope consistent with the claims. The scope of protection of the disclosure should be construed based on the following claims, and all technical ideas within the scope of equivalents thereof should be construed as being included within the scope of the disclosure.

What is claimed is:

1. An object identification method, comprising:
receiving information about a motion of a host vehicle from a dynamics sensor and receiving information about a range rate of a detected object located around the host vehicle from a radar sensor;
calculating a predicted range rate of the detected object according to the motion of the host vehicle based on the information about the motion of the host vehicle and the information about the range rate of the object received from the radar sensor; and
receiving a measured range rate of the detected object after a preset time and determining whether the detected object is a stationary object or a moving object based on the predicted range rate of the detected object and the measured range rate of the detected object.

2. The object identification method of claim 1, wherein the predicted range rate of the detected object is calculated from a predicted location of the host vehicle after the preset time based on the information about the motion of the host vehicle.

3. The object identification method of claim 2, wherein the predicted range rate of the detected object is calculated assuming that the detected object is the stationary object.

4. The object identification method of claim 1, wherein the determining of whether the detected object is the stationary object or the moving object comprises calculating a difference between the predicted range rate of the detected object and the measured range rate of the detected object and comparing the difference between the predicted range rate of the detected object and the measured range rate of the detected object with a preset threshold to determine whether the detected object is the stationary object or the moving object.

5. The object identification method of claim 4, wherein the determining of whether the detected object is the stationary object or the moving object comprises determining that the detected object is the moving object if the difference between the predicted range rate of the detected object and the measured range rate of the detected object is equal to or greater than the present threshold.

6. The object identification method of claim 4, wherein the determining of whether the detected object is the stationary object or the moving object comprises determining that the detected object is the stationary object if the difference value between the predicted range rate of the detected object and the measured range rate of the detected object is less than the predetermined threshold.

7. The object identification method of claim 1, further comprising correcting the information about the motion of the host vehicle based on a determination result of whether the detected object is the stationary object or the moving object.

8. The object identification method of claim 7, wherein the correcting of the information about the motion of the host vehicle is performed only when the detected object is determined as the stationary object.

9. The object identification method of claim 7, wherein the correcting of the information about the motion of the host vehicle comprises correcting the motion information about the motion of the host vehicle to reduce a difference value between the predicted range rate of the detected object and the measured range rate of the detected object.

10. The object identification method of claim 7, wherein the correcting of the information about the motion of the host vehicle comprises correcting the information about the motion of the host vehicle received from the dynamics sensor or correcting a dynamics parameter of the dynamics sensor.

11. An object identification device, comprising:
a memory; and
a hardware processor that, when executing computer executable instructions stored in the memory, is configured to:
receive information about a motion of a host vehicle from a dynamics sensor and receive information about a range rate of a detected object located around the host vehicle from a radar sensor;
calculate a predicted range rate of the detected object according to the motion of the host vehicle based on the information about the motion of the host vehicle and the information about the range rate of the detected object received from the radar sensor; and
receive a measured range rate of the detected object after a preset time and determine whether the detected object is a stationary object or a moving object based on the predicted range rate of the detected object and the measured range rate of the detected object.

12. The object identification device of claim 11, wherein the predicted range rate of the detected object is calculated from a predicted location of the host vehicle after the preset time based on the information about the motion of the host vehicle.

13. The object identification device of claim 12, wherein the predicted range rate of the detected object is calculated assuming that the detected object is the stationary object.

14. The object identification device of claim 11, wherein the hardware processor is configured to calculate a difference between the predicted range rate of the detected object and the measured range rate of the detected object, and compare the difference between the predicted range rate of the detected object and the measured range rate of the detected object with a preset threshold to determine whether the detected object is the stationary object or the moving object.

15. The object identification device of claim 14, wherein the hardware processor is configured to determine that the detected object is the moving object if the difference value between the predicted range rate of the detected object and the measured range rate of the detected object is equal to or greater than the preset threshold.

16. The object identification device of claim 14, wherein the hardware processor is configured to determine that the detected object is the stationary object if the difference value between the predicted range rate of the detected object and the measured range rate of the detected object is less than the preset threshold.

17. The object identification device of claim 11, wherein the hardware processor is configured to correct the information about the motion of the host vehicle based on a determination result of whether the detected object is the stationary object or the moving object.

18. The object identification device of claim 17, wherein the hardware processor is configured to correct the information about the motion of the host vehicle only when the detected object is determined as the stationary object.

19. The object identification device of claim 17, wherein the hardware processor is configured to correct the information about the motion of the host vehicle to reduce a difference value between the predicted range rate of the detected object and the measured range rate of the detected object.

20. The object identification device of claim 17, wherein the hardware processor is configured to correct the information of the motion of the host vehicle received from the dynamics sensor or correct a dynamics parameter of the dynamics sensor.
